(19) United States
(12) Patent Application Publication
(10) Pub. No.: US 2025/0005646 A1
(43) Pub. Date: Jan. 2, 2025

(54) INFORMATION PROCESSING APPARATUS, INFORMATION PROCESSING SYSTEM, AND NON-TRANSITORY COMPUTER-READABLE MEDIUM

(71) Applicant: NEC Corporation, Minato-ku, Tokyo (JP)

(72) Inventor: Risa TAGAWA, Tokyo (JP)

(73) Assignee: NEC Corporation, Minato-ku, Tokyo (JP)

(21) Appl. No.: 18/697,771

(22) PCT Filed: Oct. 27, 2021
(86) PCT No.: PCT/JP2021/039640

§ 371 Date: Apr. 2, 2024

(51) Int. Cl. G06Q 30/0601; G06F 21/32

(52) U.S. Cl. CPC G06Q 30/0631; G06F 21/32

(57) ABSTRACT

An information processing apparatus includes a collecting unit configured to collect an online behavior history on a website including a product of a user, a registration unit configured to register the behavior history in association with a user ID of the user, an acquisition unit configured to acquire biometric information of the user acquired in a real store that the user has visited from a store terminal provided in the real store, a specifying unit configured to specify the user ID of the user by controlling biometric authentication on the basis of the biometric information, and an output means configured to output the behavior history associated with the user ID to the store terminal in a case where the biometric authentication is successful.

### TECHNICAL FIELD

The present disclosure relates to an information processing apparatus, an information processing system, an information processing method, and a non-transitory computer-readable medium.

### BACKGROUND ART

There is a demand for improving sales of cosmetics in real stores. For example, Patent Literature 1 discloses a system in which a salesperson conducts face-to-face counseling with a purchaser in a real store and a recommended product recommended to the purchaser is sold on the basis of a result of the counseling.

### CITATION LIST

### Patent Literature

Patent Literature 1: Japanese Unexamined Patent Application Publication No. 2021-015433

### SUMMARY OF INVENTION

### Technical Problem

In the system of Patent Literature 1, selection of a recommended product recommended to a purchaser largely depends on the experience of a salesperson who provides counseling, and there may be a question as to whether the product is a product with which the purchaser is really satisfied. It is desired that purchasers be able to purchase products in a real store with satisfaction, thereby increasing sales of cosmetics in the real store.

In view of the above-described problems, an object of the present disclosure is to provide an information processing apparatus, an information processing system, an information processing method, and a non-transitory computer-readable medium capable of improving sales of a product in a real store.

### Solution to Problem

According to an aspect of the present disclosure, there is provided an information processing apparatus including collecting means for collecting a user's online behavior history on a website including a product;
registration means for registering the behavior history in association with a user ID of the user;
acquisition means for acquiring biometric information of the user acquired in a real store that the user has visited from a store terminal provided in the real store;
specifying means for specifying the user ID of the user by controlling biometric authentication on the basis of the biometric information; and
output means for outputting the behavior history associated with the user ID to the store terminal in a case where the biometric authentication is successful.

According to another aspect of the present disclosure, there is provided an information processing system including
a store terminal provided in a real store; and
an information processing apparatus connected to the store terminal via a wireless or wired communication line, in which
the information processing apparatus includes
collecting means for collecting a user's online behavior history on a website including a product,
registration means for registering the behavior history in association with a user ID of the user,
acquisition means for acquiring biometric information of the user acquired in a real store that the user has visited from a store terminal,
specifying means for specifying the user ID of the user by controlling biometric authentication on the basis of the biometric information, and
output means for outputting the behavior history associated with the user ID to the store terminal in a case where the biometric authentication is successful.

According to still another aspect of the present disclosure, there is provided an information processing method including:
collecting a user's online behavior history on a website including a product;
registering the behavior history in association with a user ID of the user;
acquiring biometric information of the user acquired in a real store that the user has visited from a store terminal provided in the real store;
specifying the user ID of the user by controlling biometric authentication on the basis of the biometric information; and
outputting the behavior history associated with the user ID to the store terminal in a case where the biometric authentication is successful.

According to still another aspect of the present disclosure, there is provided a non-transitory computer-readable medium storing an information processing program for causing a computer to execute:
a step of collecting a user's online behavior history on a website including a product;
a step of registering the behavior history in association with a user ID of the user;
a step of acquiring biometric information of the user acquired in a real store that the user has visited from a store terminal provided in the real store;
a step of specifying the user ID of the user by controlling biometric authentication on the basis of the biometric information; and
a step of outputting the behavior history associated with the user ID to the store terminal in a case where the biometric authentication is successful.

### Advantageous Effects of Invention

According to the present disclosure, it is possible to provide an information processing apparatus, an information processing system, an information processing method, and a non-transitory computer-readable medium capable of improving sales of a product in a real store.

### BRIEF DESCRIPTION OF DRAWINGS

FIG. 1 is a configuration diagram exemplifying an information processing system according to a first example embodiment.

FIG. 2 is a block diagram exemplifying an information processing apparatus according to the first example embodiment.

FIG. 3 is a diagram exemplifying a behavior history of a user collected by a collecting unit of the information processing apparatus according to the first example embodiment.

FIG. 4 is a diagram exemplifying a registration screen displayed on a user terminal when a registration unit of the information processing apparatus according to the first example embodiment registers a user.

FIG. 5 is a diagram exemplifying a registration screen displayed on a user terminal when the registration unit of the information processing apparatus according to the first example embodiment registers a user.

FIG. 6 is a diagram exemplifying a display screen displayed on a store terminal when an output unit of the information processing apparatus according to the first example embodiment outputs a behavior history, user information, and product information associated with the user information to the store terminal.

FIG. 7 is a flowchart exemplifying an information processing method according to the first example embodiment.

FIG. 8 is a block diagram exemplifying an information processing apparatus according to a second example embodiment.

FIG. 9 is a diagram exemplifying a reservation screen displayed on a user terminal when a reservation notification unit of the information processing apparatus according to the second example embodiment accepts a reservation.

FIG. 10 is a diagram exemplifying a reservation completion screen displayed on the user terminal when the reservation notification unit of the information processing apparatus according to the second example embodiment notifies a user terminal of reservation completion.

FIG. 11 is a diagram exemplifying a reservation status screen displayed on a store terminal when a reservation notification unit of the information processing apparatus according to the second example embodiment is notified of reservation completion from the store terminal.

FIG. 12 is a flowchart exemplifying an information processing method according to the second example embodiment.

FIG. 13 is a flowchart exemplifying a reservation notification method according to the second example embodiment.

FIG. 14 is a block diagram exemplifying an information processing apparatus according to a third example embodiment.

FIG. 15 is a diagram exemplifying a purchase screen displayed on a store terminal when a purchase acceptance unit of the information processing apparatus according to the third example embodiment accepts purchase of a product from a store terminal.

FIG. 16 is a flowchart exemplifying an information processing method according to the third example embodiment.

FIG. 17 is a configuration diagram exemplifying an information processing system according to a fourth example embodiment.

FIG. 18 is a block diagram exemplifying an information processing apparatus according to the fourth example embodiment.

FIG. 19 is a block diagram exemplifying a store terminal according to the fourth example embodiment.

FIG. 20 is a block diagram illustrating a configuration of a user terminal according to the fourth example embodiment.

FIG. 21 is a block diagram illustrating a configuration of a face authentication apparatus according to the fourth example embodiment.

FIG. 22 is a flowchart illustrating a flow of a face information registration process according to the fourth example embodiment.

FIG. 23 is a flowchart illustrating a flow of a face authentication process according to the fourth example embodiment.

### EXAMPLE EMBODIMENT

Example embodiments of the present disclosure will be described in detail below with reference to the drawings. In the drawings, the same or corresponding elements are denoted by the same reference numerals, and repeated description thereof will be omitted as necessary to clarify the description.

### FIRST EXAMPLE EMBODIMENT

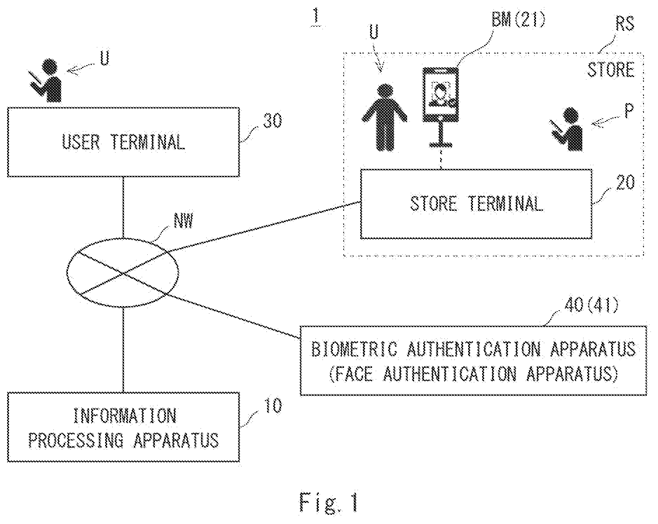

An information processing system according to a first example embodiment will be described. FIG. 1 is a configuration diagram exemplifying an information processing system according to a first example embodiment. As illustrated in FIG. 1, the information processing system 1 includes an information processing apparatus 10 and a store terminal 20. The store terminal 20 is provided in a real store RS. The real store RS is also referred to as a real store. The real store RS is a store that actually exists. The information processing apparatus 10 is connected to the store terminal 20 via a wireless or wired communication line. For example, the information processing apparatus 10 is connected to the store terminal 20 via a network NW. The network NW may be a wireless or wired communication line and may employ a communication protocol of any type. The information processing apparatus 10 may be connected to each of store terminals 20 of a plurality of real stores RS. The store terminal 20 may be an information terminal such as a personal computer or a portable terminal such as a smartphone or a tablet terminal carried by a salesperson P of the real store RS.

The information processing apparatus 10 may be connected to a user terminal 30 used by a user U via a wireless or wired communication line. For example, the user terminal 30 may be connected to the information processing apparatus 10 via the network NW. The user terminal 30 includes, for example, a portable terminal such as a smartphone or a tablet terminal, and a personal computer. The user U acquires information regarding a product desired to be purchased online from a website including the product.

The information processing apparatus 10 may be connected to a biometric authentication apparatus 40 via a wireless or wired communication line. For example, the biometric authentication apparatus 40 may be connected to the information processing apparatus 10 via the network NW. The biometric authentication apparatus 40 specifies the user U from biometric information of the user U. The biometric information is, for example, a face image. In that case, the biometric authentication apparatus 40 is a face authentication apparatus 41. Note that the biometric information is not limited to a face image as long as the user U can be specified, and may be fingerprint information, palm print information, retina information, iris information, vein information, voiceprint information, or the like.

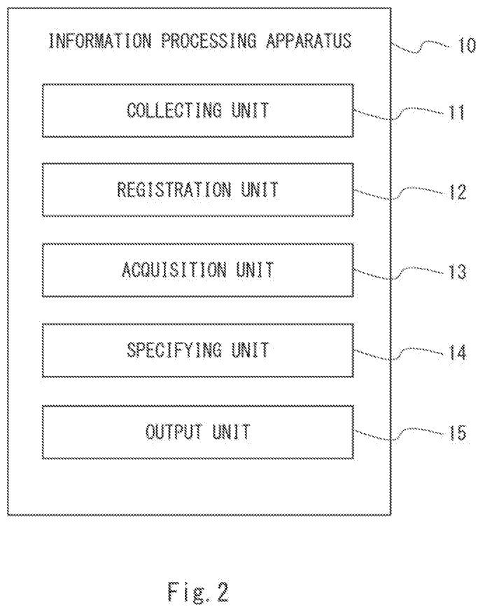

FIG. 2 is a block diagram exemplifying the information processing apparatus 10 according to the first example embodiment. As illustrated in FIG. 2, the information processing apparatus 10 is separated from the information processing system 1 and becomes a product as a single unit. The information processing apparatus 10 includes a collecting unit 11, a registration unit 12, an acquisition unit 13, a specifying unit 14, and an output unit 15. The collecting unit 11, the registration unit 12, the acquisition unit 13, the specifying unit 14, and the output unit 15 have functions as collecting means, registration means, acquisition means, specifying means, and output means, respectively.

The collecting unit 11 collects an online behavior history on a website including a product of the user U. The product is, for example, a cosmetic product. Note that the product is not limited to a cosmetic product as long as the user U can receive advice on the use of the product when purchasing the product in the real store RS and can purchase the product in the real store RS or the website.

When accessing a website of a product such as a cosmetic product via the user terminal 30, the user U logs in by using, for example, a user ID. The user U acquires information regarding the product online on the website including the product.

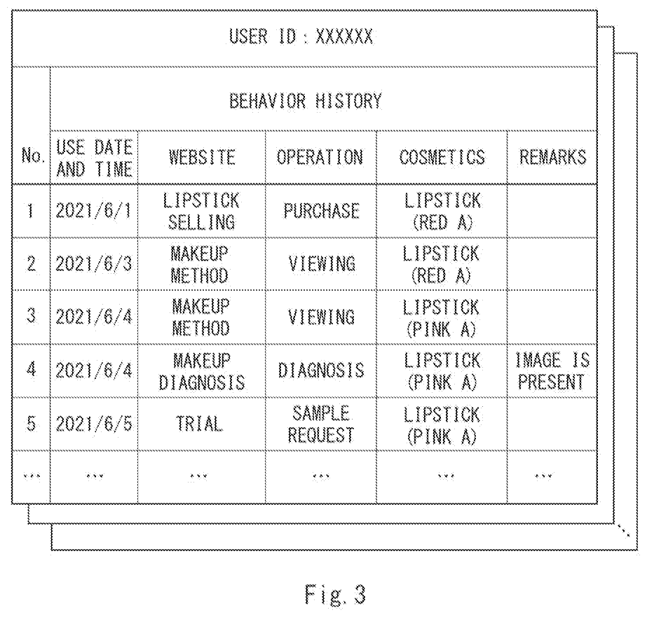

FIG. 3 is a diagram exemplifying a behavior history of the user U collected by the collecting unit 11 of the information processing apparatus 10 according to the first example embodiment. As illustrated in FIG. 3, for example, the user U purchases a lipstick (red A) on a website related to sales of the lipstick and views a makeup method of the lipstick (red A) on a website related to the makeup method. The user U views a makeup method of a lipstick (pink A) on a website related to the makeup method, and diagnoses the lipstick (pink A) on a website related to makeup diagnosis. An image in this case is updated on the website. The user U requests a sample of the lipstick (pink A) on a website related to a trial. The user U may receive a suggestion of a makeup method and a cosmetic product according to the face, the skin, the shape of the face, the hairstyle, and the clothes of the user U on the website including the cosmetic product, or may perform a virtual trial and purchase of the cosmetic product on the website. As described above, the user U can easily try cosmetics and makeup methods suitable for the user U from many cosmetics on the website. The collecting unit 11 collects a behavior history of the user U on the website that the user U logs in by using the user ID.

When registering the user U in advance, the registration unit 12 registers the user information input by the user in a storage apparatus together with the user ID.

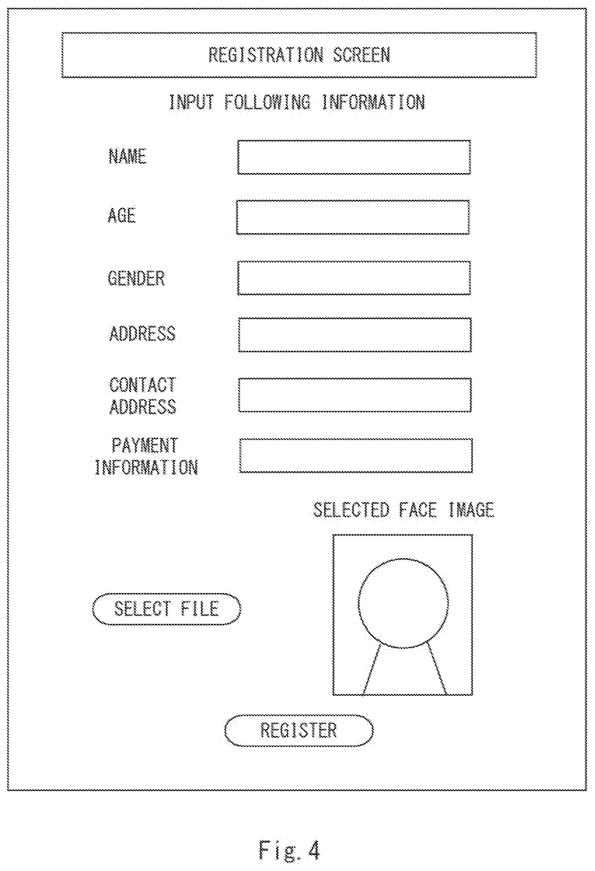

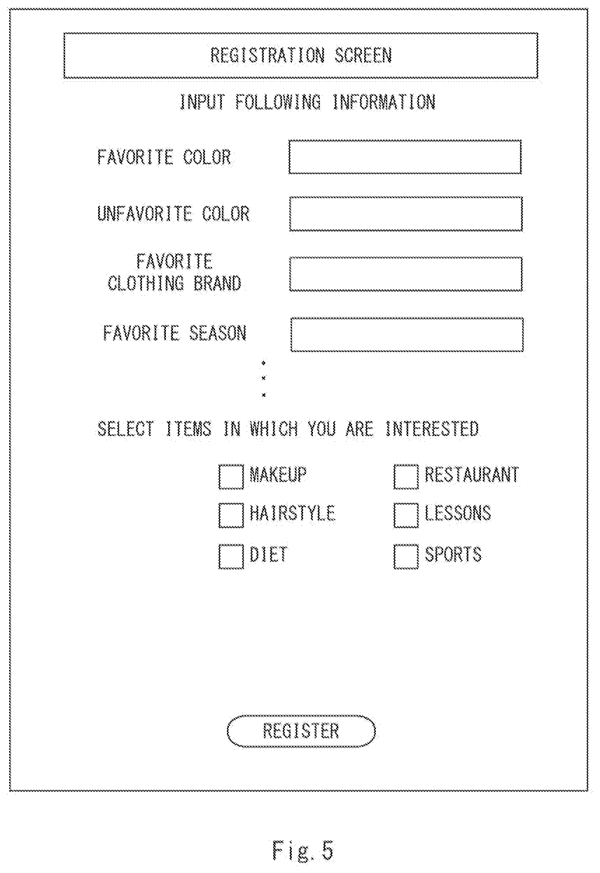

FIGS. 4 and 5 are diagrams exemplifying registration screens displayed on the user terminal 30 when the registration unit 12 of the information processing apparatus 10 according to the first example embodiment registers the user U. As illustrated in FIG. 4, the registration screen displayed on the user terminal 30 has an input field such that the user information can be input. The user information includes attribute information of the user U such as a name, an age, a gender, an address, a contact address, and payment information of the user U. Note that the attribute information of the user U may include, in addition to these, a date of birth, an occupation, an educational background, a hometown, and the like. The user information includes biometric information such as a face image of the user U. As illustrated in FIG. 5, the user information may include information indicating the preference of the user U such as a favorite color, an unfavorite color, a favorite clothing brand, a favorite season, and an item of interest. The registration unit 12 registers the user information input by the user U in association with the user ID of the user U.

The registration unit 12 may register product information associated with the user information. Specifically, for example, the registration unit 12 may classify products in fashion for each generation, for each occupation, for each educational background, and for each hometown in advance and store the products in the storage apparatus. For example, the registration unit 12 may classify a product preferred by a person having various preferences in advance and store the product in the storage apparatus. As described above, the product information associated with the user information includes products that are in fashion for people of the same generation, the same occupation, the same educational background, and the same hometown as the user U.

The registration unit 12 registers the behavior history of the user U collected by the collecting unit 11 in association with the user ID. Therefore, the behavior history collected by the collecting unit 11 is associated with the user ID together with the user information and the product information associated with the user information.

The acquisition unit 13 acquires the biometric information of the user U acquired in the real store RS that the user U has visited from the store terminal 20. The real store RS includes a biometric information acquisition apparatus BM. A face image will be described as an example of the biometric information. Therefore, an image acquisition apparatus 21 will be described as an example of the biometric information acquisition apparatus BM.

The image acquisition apparatus 21 is connected to the store terminal 20 via a wireless or wired communication line. Note that the image acquisition apparatus 21 may use a camera function of the store terminal 20. For example, the camera of the store terminal 20 may function as the image acquisition apparatus 21. The image acquisition apparatus 21 acquires the face image of the user U when the user U visits the real store RS. The image acquisition apparatus 21 outputs the acquired face image to the store terminal 20. The store terminal 20 outputs the acquired face image to the information processing apparatus 10. As described above, the acquisition unit 13 acquires the face image of the user U from the store terminal 20.

The specifying unit 14 specifies the user ID of the user U by controlling biometric authentication on the basis of the biometric information. Specifically, the specifying unit 14 specifies the user ID of the user U by causing the biometric authentication apparatus 40 to perform biometric authentication by using the biometric information. In a case where the biometric information is a face image, the biometric authentication apparatus 40 is a face authentication apparatus 41. The specifying unit 14 outputs the face image acquired by the acquisition unit 13 to the face authentication apparatus 41. The face authentication apparatus 41 acquires the face image acquired in the real store RS and executes face authentication using the face image. As a result, the face authentication apparatus 41 specifies the user ID. In a case where the user ID is specified, the face authentication apparatus 41 outputs the user ID to the information processing apparatus 10. Accordingly, the specifying unit 14 specifies the user ID of the user U. As described above, when the user U visits the real store RS, the face image of the user U is transmitted to the face authentication apparatus 41 via the store terminal 20 and the information processing apparatus 10, and the face authentication is performed.

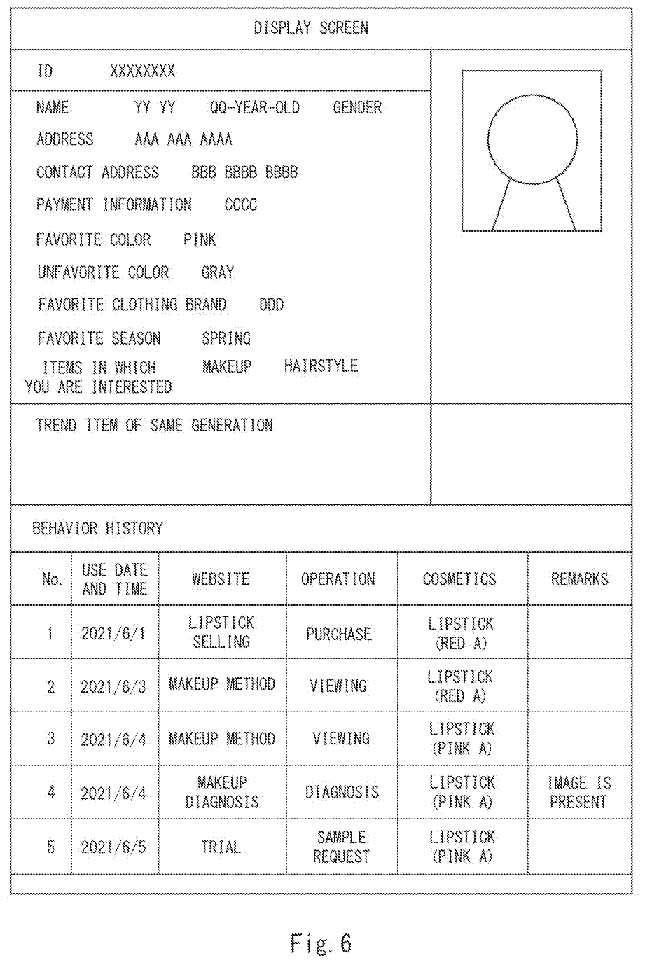

In a case where the biometric authentication is successful, the output unit 15 outputs the behavior history associated with the user ID. In addition to the behavior history, the output unit 15 may output at least one of the user information of the user U and the product information associated with the user information to the store terminal 20. FIG. 6 is a diagram exemplifying a display screen displayed on the store terminal 20 when the output unit 15 of the information processing apparatus 10 according to the first example embodiment outputs the behavior history, the user information, and the product information associated with the user information to the store terminal 20. As illustrated in FIG. 6, when the user U visits the real store RS, the store terminal 20 displays the behavior history associated with the user ID of the user U, the user information, the product information associated with the user information, and the like. Therefore, since the salesperson P of the real store RS can ascertain a product in which the user U is interested from the various types of information associated with the user ID, it is possible to propose a more accurate product.

The information processing apparatus 10 described above is, for example, an information processing apparatus such as a server. The information processing apparatus 10 may include a processor, a memory, and a storage apparatus as constituents (not illustrated). The storage apparatus may store processing performed by each constituent of the information processing apparatus as a program. The processor may read the program from the storage apparatus into the memory and execute the program. As a result, the processor realizes the functions of the collecting unit 11, the registration unit 12, the acquisition unit 13, the specifying unit 14, and the output unit 15.

Each constituent included in the information processing apparatus 10 may be realized by dedicated hardware. Some or all of the constituents may be implemented by general-purpose or dedicated circuitry, a processor, or the like, or a combination thereof. These units may be configured with a single chip or may be configured with a plurality of chips connected via a bus. Some or all of the constituents of each apparatus may be implemented by, for example, a combination of the above-described circuit and a program. For example, a central processing unit (CPU), a graphics processing unit (GPU), a field-programmable gate array (FPGA), or a quantum processor (quantum computer control chip) may be used as the processor.

In a case where some or all of the constituents of the information processing apparatus 10 are implemented by a plurality of information processing apparatuses, circuits, and the like, the plurality of information processing apparatuses, circuits, and the like may be disposed in a centralized manner or in a distributed manner. For example, the information processing apparatus, the circuit, and the like may be implemented as a form in which each is connected via a communication network, such as a client server system and a cloud computing system. The function of the information processing apparatus 10 may be provided in a software as a service (SaaS) format.

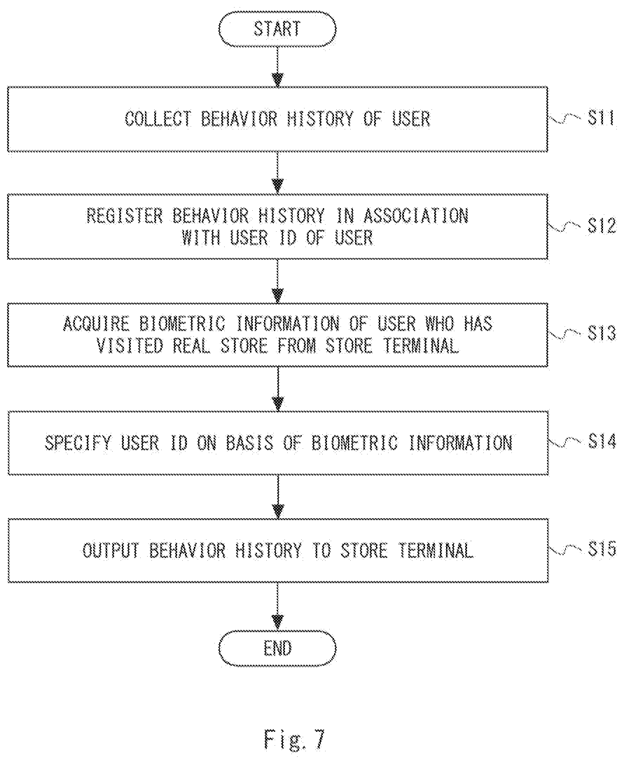

Next, an information processing method performed by the information processing apparatus 10 will be described with reference to a flowchart. FIG. 7 is a flowchart exemplifying the information processing method according to the first example embodiment. As illustrated in step S11 in FIG. 7, first, a behavior history of the user U is collected. For example, the collecting unit 11 of the information processing apparatus 10 collects an online behavior history on a website including a product of the user U.

Next, as illustrated in step S12, the behavior history is registered in association with the user ID of the user U. For example, the registration unit 12 registers the behavior history of the user U who has performed on the website including a product in association with the user ID of the user U.

Next, as described in step S13, biometric information of the user U who has visited the real store RS is obtained from the store terminal 20. For example, the acquisition unit 13 acquires the biometric information (a face image or the like) of the user U acquired in the real store RS that the user U has visited from the store terminal 20.

Next, as illustrated in step S14, a user ID is specified on the basis of the biometric information. For example, the specifying unit 14 specifies the user ID of the user by controlling biometric authentication on the basis of the biometric information (a face image or the like).

Next, as illustrated in step S15, the behavior history is output to the store terminal 20. For example, in a case where the biometric authentication is successful, the output unit 15 outputs the behavior history associated with the user ID to the store terminal 20. Note that the output unit 15 may output the user information and the product information associated with the user information to the store terminal 20 in addition to the behavior history.

Next, effects of the present example embodiment will be described. In the present example embodiment, the information processing apparatus 10 outputs an online behavior history on a website including a product of the user U to the store terminal 20 in response to the biometric authentication of the user U at the time of visiting the store. Therefore, the user U can obtain or try information regarding the product on the website, and then can purchase the product in the real store RS. The salesperson P of the real store RS can recommend a product reflecting the behavior history of the user U to the user U. Due to such fusion of the online behavior history and the product recommendation of the real store RS, the user U is satisfied with the product recommended by the salesperson P and purchases the product. Therefore, the sales of the real store RS can be improved. Since the user U becomes a repeater to the real store RS by obtaining a sense of satisfaction, the sales of the real store RS can be further improved. For example, customers from a light layer starting to use cosmetics can be enclosed and sales can be improved.

In particular, in a case where the product is a cosmetic product, the user U tends to desire not only to satisfy the user, but also to incorporate opinions as to whether or not the product is suitable for other people and fashion. In the present example embodiment, since it is possible to collect information by oneself online and purchase cosmetics after incorporating the opinion of the salesperson P of the real store RS, it is possible to improve the sense of satisfaction. The information processing apparatus 10 causes the store terminal 20 to output the user information and the product information associated with the user information in addition to the behavior history. The product information associated with the user information includes a product that is in fashion for at least one of the same generation, the same occupation, the same educational background, and the same hometown as the user. Therefore, even if the experience is shallow, the salesperson P can recommend a product in fashion to the user U, and it is possible to improve the sense of satisfaction of the user U.

### SECOND EXAMPLE EMBODIMENT

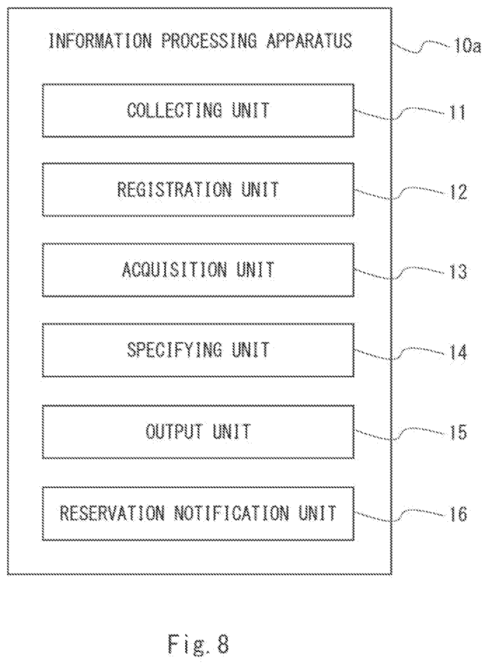

Next, an information processing apparatus according to a second example embodiment will be described. The information processing apparatus according to the present example embodiment further includes a reservation notification unit that receives a reservation of the user U for visiting the real store RS and notifies the store terminal 20 of the reservation. FIG. 8 is a block diagram exemplifying an information processing apparatus according to a second example embodiment. As illustrated in FIG. 8, an information processing apparatus 10a further includes a reservation notification unit 16. The reservation notification unit 16 has a function as reservation notification means. In a case where the user U visits the real store RS, the user U makes a reservation from the user terminal 30 to the information processing apparatus 10 on a website.

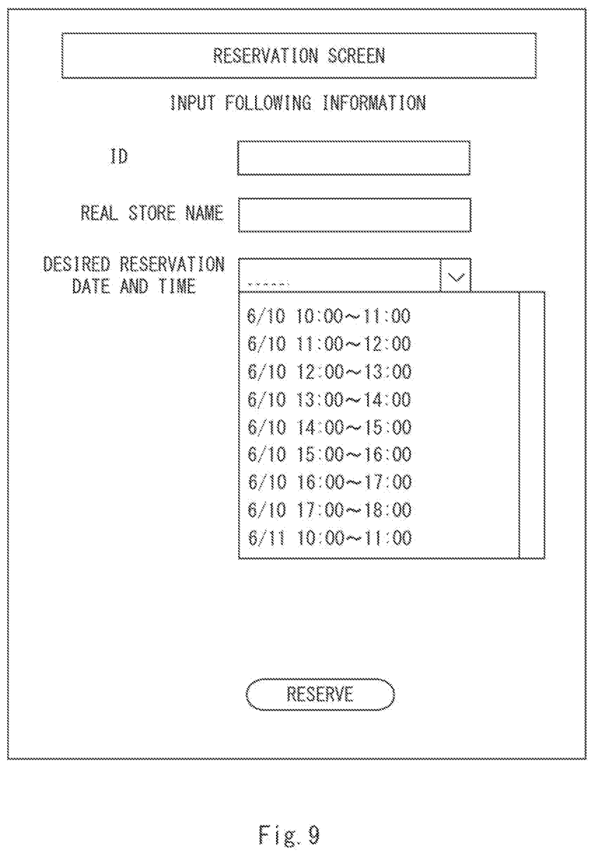

FIG. 9 is a diagram exemplifying a reservation screen displayed on the user terminal 30 when the reservation notification unit 16 of the information processing apparatus 10a according to the second example embodiment accepts a reservation. As illustrated in FIG. 9, the reservation notification unit 16 of the information processing apparatus 10a receives a reservation from the user terminal 30. Note that the reservation notification unit 16 may acquire a reservable time in advance from the store terminal 20. The reservation notification unit 16 may cause the user U to select a reservation time from among reservable times.

The reservation notification unit 16 notifies the store terminal 20 of the reservation from the user U. When the reservation is accepted from the user U, the store terminal 20 checks whether the reservation time is free. In a case where the reservation time is free, the store terminal 20 accepts the reservation. In this case, the store terminal 20 notifies the reservation notification unit 16 of the information processing apparatus 10 of the completion of the reservation. Thus, the reservation notification unit 16 notifies the user terminal 30 of the completion of the reservation. Note that the reservation of the user U for a visit to the real store RS and information regarding a product handled in the real store RS at the time of the visit may be collected by the collecting unit 11 as the behavior history of the user U and registered by the registration unit 12.

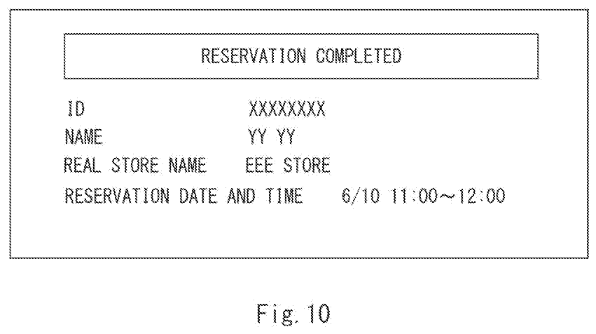

FIG. 10 is a diagram exemplifying a reservation completion screen displayed on the user terminal 30 when the reservation notification unit 16 of the information processing apparatus 10a according to the second example embodiment notifies the user terminal 30 of completion of a reservation. As illustrated in FIG. 10, when the reservation notification unit 16 notifies the user terminal 30 of the completion of the reservation, the user terminal 30 displays the name of the real store RS for which the reservation has been made and the reservation date and time.

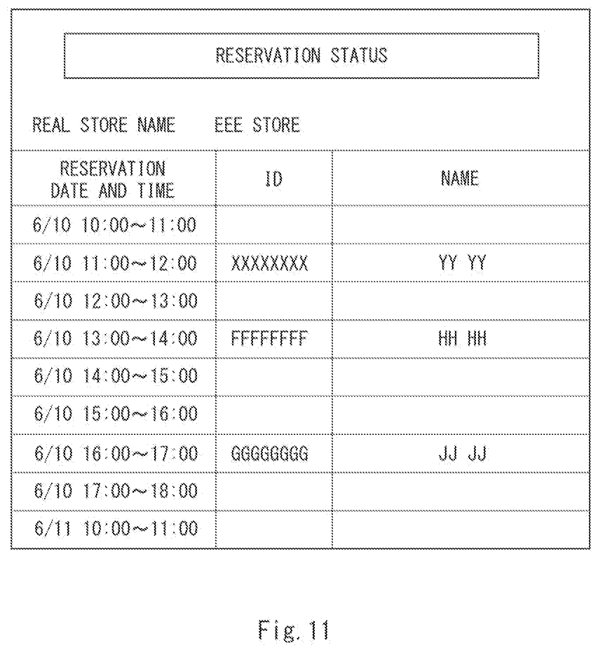

FIG. 11 is a diagram exemplifying a reservation status screen displayed on the store terminal 20 when the reservation notification unit 16 of the information processing apparatus 10a according to the second example embodiment is notified of the completion of the reservation from the store terminal 20. As illustrated in FIG. 11, the store terminal 20 notifies the reservation notification unit 16 of the completion of the reservation and displays a reservation status of the real store RS.

In a case where the reservation time desired by the user U is not free and the reservation from the user U cannot be accepted, the store terminal 20 notifies the reservation notification unit 16 of the information processing apparatus 10a to make a reservation again. At that time, a reservable time may be sent.

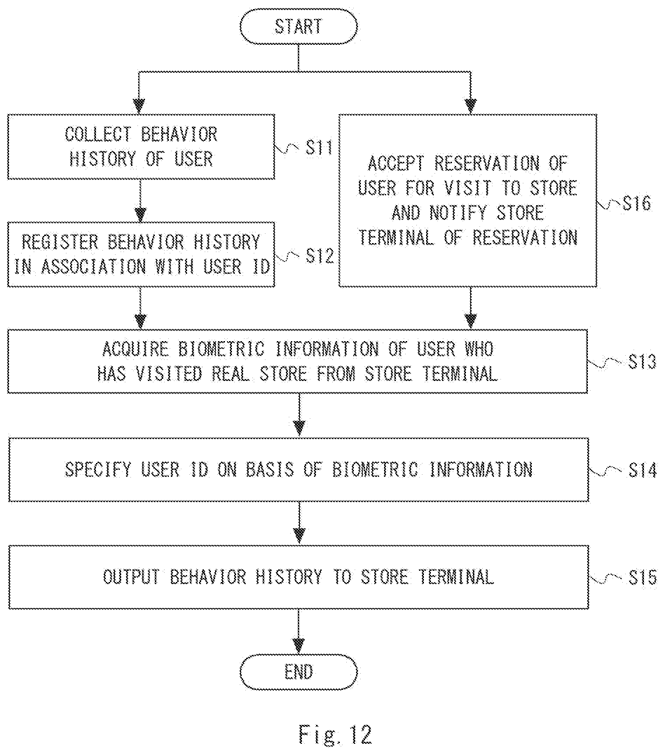

Next, a method in which the user U reserves the real store RS described above will be described with reference to a flowchart. FIG. 12 is a flowchart exemplifying an information processing method according to the second example embodiment. Steps S11 to S15 in FIG. 12 are similar to the information processing method of the first example embodiment. As illustrated in step S16 in FIG. 12, before step S13, the reservation for the visit to the real store RS from the user U is accepted, and the store terminal 20 is notified of the reservation. For example, the reservation notification unit 16 of the information processing apparatus 10 accepts the reservation of the user U for a visit to the real store RS and notify the store terminal 20 of the reservation. Step S16 may be performed before or after step S11 and step S12, or may be performed in parallel with step S11 and step S12.

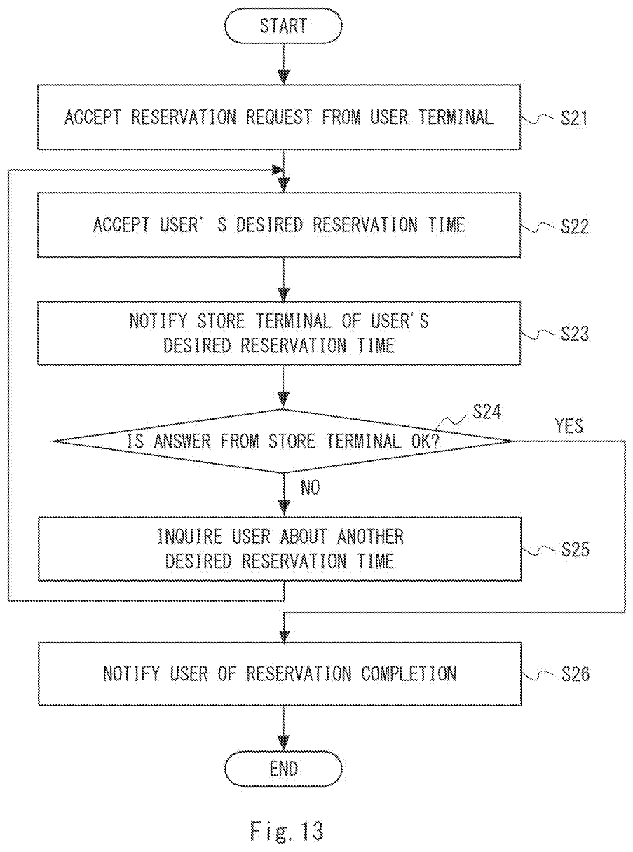

FIG. 13 is a flowchart exemplifying a reservation notification method according to the second example embodiment; As illustrated in step S21 in FIG. 13, the reservation notification unit 16 accepts a request for a reservation for a visit to the real store RS from the user terminal 30. Next, as described in step S22, the reservation notification unit 16 accepts the desired reservation time of the user. Next, as illustrated in step S23, the reservation notification unit 16 notifies the store terminal 20 of the desired reservation time of the user U. In response to this, the store terminal 20 checks whether the desired reservation time of the user U is free. In a case where the desired reservation time of the user U is free, the store terminal 20 notifies the reservation notification unit 16 that the reservation is possible. On the other hand, in a case where the desired reservation time of the user U is not free, the store terminal 20 notifies the reservation notification unit 16 that the reservation is impossible.

Therefore, as illustrated in step S24, the reservation notification unit 16 determines whether an answer that the reservation is possible has been sent from the store terminal 20. In step S24, in a case where the store terminal 20 sends NO in which the reservation is impossible, the user U is inquired about another desired reservation time as illustrated in step S25. Steps S22 to S24 are repeatedly performed. In step S24, in a case where the store terminal 20 sends YES in which the reservation is possible, the reservation notification unit 16 notifies the user U of the completion of the reservation as illustrated in step S26.

According to the present example embodiment, since the user U can reserve a visit to the real store RS, the convenience for the user can be improved. The behavior history of the user U includes the reservation for the visit to the real store RS and information regarding a product associated with the visit. Therefore, the salesperson P of the real store RS can ascertain that the user U has already been advised in the real store RS and the product that has already been handled. As a result, it is possible to curve advice and a proposal of a product overlapping with those at the time of the previous visit. Other configurations and effects are included in the description of the first example embodiment.

### THIRD EXAMPLE EMBODIMENT

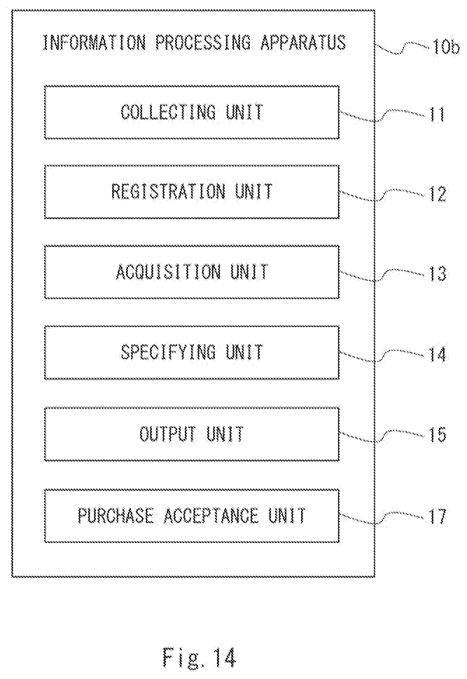

Next, an information processing apparatus according to a third example embodiment will be described. The information processing apparatus according to the present example embodiment further includes a purchase acceptance unit that accepts purchase of a product desired by the user U online on a website from the store terminal 20. FIG. 14 is a block diagram exemplifying an information processing apparatus according to the third example embodiment. As illustrated in FIG. 14, an information processing apparatus 10b further includes a purchase acceptance unit 17. The purchase acceptance unit 17 has a function as purchase acceptance means.

The purchase acceptance unit 17 accepts purchase of a product on the website from the store terminal 20 in the real store RS. For example, in a case where a product to be purchased according to the proposal from the salesperson P is not present in the real store RS, or in a case where the user U wants the product to be purchased according to the proposal from the salesperson P to be delivered to the home, the user U purchases the product from the store terminal 20. In such a case, the store terminal 20 outputs the product to be purchased and the user information to the information processing apparatus 10b. Note that the product to be purchased from the store terminal 20 and the user information such as a delivery destination of the product may be collected by the collecting unit 11 and registered by the registration unit 12 as the behavior history of the user U.

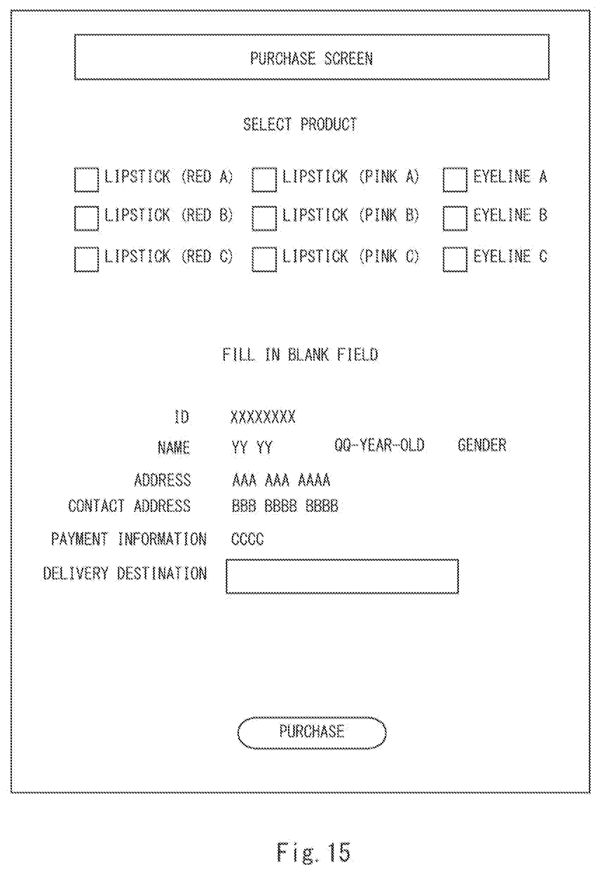

FIG. 15 is a diagram exemplifying a purchase screen displayed on the store terminal 20 when the purchase acceptance unit 17 of the information processing apparatus 10b according to the third example embodiment accepts purchase of a product from the store terminal 20. As illustrated in FIG. 15, when requesting purchase from the store terminal 20 to the purchase acceptance unit 17, the store terminal 20 causes the user U or the salesperson P to input the product to be purchased and the user information. The store terminal 20 displays the behavior history, the user information, and the like of the user U when the user U visits the store. Therefore, on the purchase screen, only a delivery destination of the purchased product may be input.

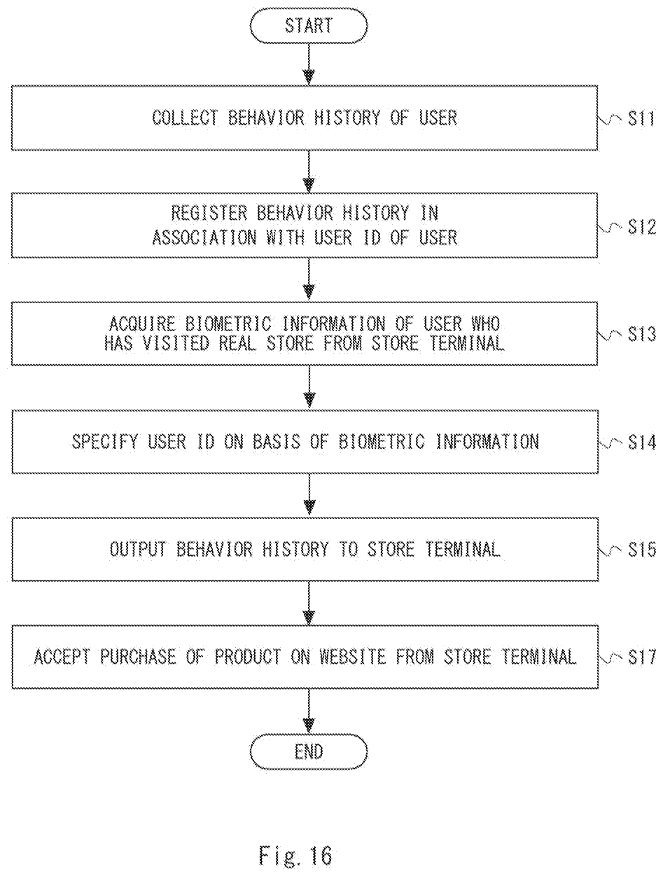

Next, a method of purchasing a product from the store terminal 20 via the purchase acceptance unit 17 will be described with reference to a flowchart. FIG. 16 is a flowchart exemplifying an information processing method according to the third example embodiment. Steps S11 to S15 in FIG. 16 are similar to the information processing method of the first example embodiment. As illustrated in step S17 in FIG. 16, after step S15, purchase of a product on the website is accepted from the store terminal 20. For example, the purchase acceptance unit 17 accepts the purchase of the product on the website from the store terminal 20.

According to the present example embodiment, even in a case where the product to be purchased according to the proposal from the salesperson P is not present in the real store, or in a case where the product to be purchased according to the proposal from the salesperson P is desired to be delivered to the home, the user U can purchase the product, and the convenience for the user U can be improved. Other configurations and effects are included in the description of the first and second example embodiments.

### FOURTH EXAMPLE EMBODIMENT

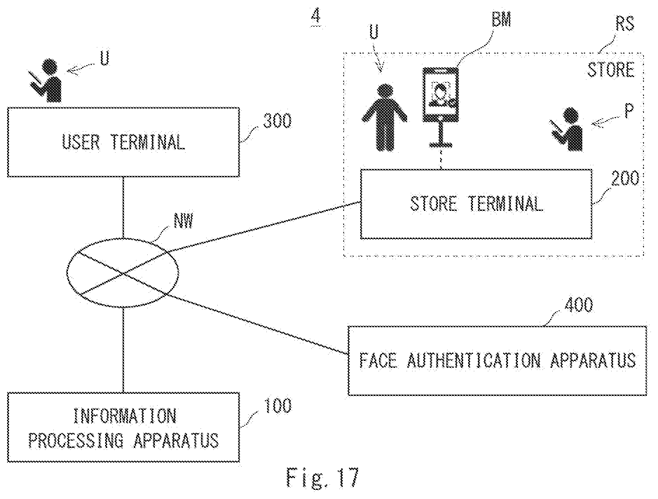

Next, an information processing system according to a fourth example embodiment will be described. In the present example embodiment, the information processing system will be described in more detail. FIG. 17 is a configuration diagram exemplifying an information processing system according to the fourth example embodiment. An information processing system 4 includes an information processing apparatus 100, a store terminal 200, a user terminal 300, and a face authentication apparatus 400. The apparatuses and the terminals are connected via a wireless or wired network NW. The information processing apparatus 100, the store terminal 200, the user terminal 300, and the face authentication apparatus 400 are examples of the information processing apparatuses 10 to 10b, the store terminal 20, the user terminal 30, and the biometric authentication apparatus 40 described above, respectively. Each configuration will be described below.

### <Information Processing Apparatus>

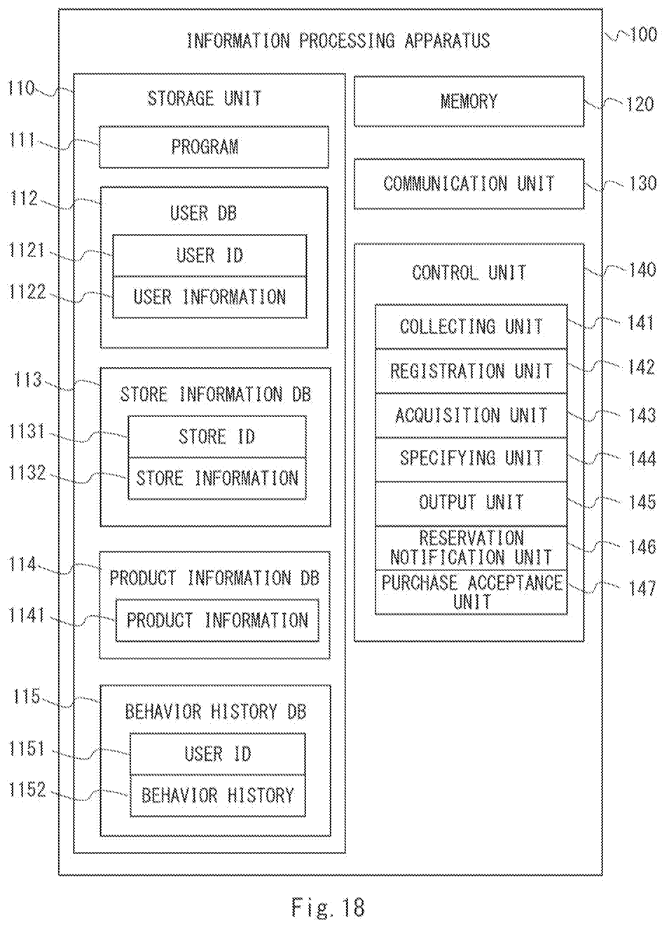

FIG. 18 is a block diagram exemplifying an information processing apparatus 100 according to the fourth example embodiment. The information processing apparatus 100 includes a storage unit 110, a memory 120, a communication unit 130, and a control unit 140. The storage unit 110, the memory 120, the communication unit 130, and the control unit 140 have functions as storage means, memory means, communication means, and control means, respectively. The storage unit 110 is a storage apparatus such as a hard disk or a flash memory. The storage unit 110 stores a program 111, a user DB 112, a store information DB 113, a product information DB 114, and a behavior history DB 115. The program 111 is a computer program in which the processing of the information processing method is implemented.

The user DB 112 stores user information of the user U. Specifically, the user DB 112 stores the user information 1122 in association with the user ID 1121. The user ID 1121 may be issued by the face authentication apparatus 400 when biometric information is registered. The user information 1122 is information regarding the user U, and may include, for example, attribute information of the user U and information indicating preference of the user U. The attribute information may include at least one of an age, a place of residence, a gender, a family structure, a place of employment, allergy information, and religious information. The attribute information may include a work environment, for example, whether work is indoor work or outdoor work. The information indicating the preference of the user U may include information regarding at least one of a hobby of the user U, a field of interest of the user U, and a product or service evaluated by the user U.

The store information DB 113 is a database that stores various types of information related to the real store RS. Specifically, the store information DB 113 includes a store ID 1131 and store information 1132. The store ID 1131 is information for identifying the real store RS. The store information 1132 includes basic information of the real store RS, information regarding a product or a service provided in the real store RS, or campaign information or preferential information of the product or the service.

The product information DB 114 is a database that stores various types of information related to products. The product information DB includes product information 1141. The product information 1141 includes product information associated with the user information, for example, information regarding a product that is in fashion for at least one of the same generation, the same occupation, the same educational background, and the same hometown as the user U.

The behavior history DB 115 stores a behavior history performed by the user U on a website including a product. The behavior history DB 115 stores a user ID 1151 and a behavior history 1152 in association with each other. In the behavior history DB 115, a behavior history of the user U is recorded for each user ID. For example, the behavior history includes a date and time of behavior, a website used, and a product used.

The memory 120 is a volatile storage apparatus such as a random access memory (RAM), and is a storage area for temporarily storing information during an operation of the control unit 140. The communication unit 130 is a communication interface with the network N.

The control unit 140 is a processor that controls each constituent of the information processing apparatus 100, that is, a control apparatus. The control unit 140 reads the program 111 from the storage unit 110 into the memory 120 and executes the program 111. Thus, the functions of the collecting unit 141, the registration unit 142, the acquisition unit 143, the specifying unit 144, the output unit 145, the reservation notification unit 146, and the purchase acceptance unit 147 are realized. The collecting unit 141, the registration unit 142, the acquisition unit 143, the specifying unit 144, the output unit 145, the reservation notification unit 146, and the purchase acceptance unit 147 are respective examples of the collecting unit 11, the registration unit 12, the acquisition unit 13, the specifying unit 14, the output unit 15, the reservation notification unit 16, and the purchase acceptance unit 17 described above.

The collecting unit 141 collects an online behavior history on a website including a product of the user U. In a case where biometric information (for example, a face image) has been received from the user terminal 300, the registration unit 142 transmits a biometric information registration request to the face authentication apparatus 400. In a case where the face authentication apparatus 400 registers the biometric information and issues the user ID, the registration unit 142 registers the user ID in the user DB 112. In a case where a member registration request has been received from the user terminal 300, the registration unit 142 registers the user information of the user U in the user DB 112 in association with the user ID of the user U used by the user terminal 300. In a case where an information provision request or a biometric information payment request has been received from the store terminal 200, the acquisition unit 143 acquires biometric information included in the request. The acquisition unit 143 supplies the biometric information to the specifying unit 144.

The specifying unit 144 specifies the user U by controlling face authentication on the basis of a face image. For example, the specifying unit 144 causes the face authentication apparatus 400 to perform face authentication on the face image acquired from the store terminal 200. For example, the specifying unit 144 transmits a face authentication request including the acquired face image to the face authentication apparatus 400 via the network NW. Note that the specifying unit 144 may extract a face region of the user U from the face image and cause the extracted image to be included in the face authentication request. The specifying unit 144 may extract face feature information from the face region and cause the face feature information to be included in the face authentication request. The specifying unit 144 receives a face authentication result from the face authentication apparatus 400. Accordingly, the specifying unit 144 specifies the user ID of the user U.

In a case where the biometric authentication is successful, the output unit 145 outputs the behavior history associated with the user ID to the store terminal 200. In addition to the behavior history, the output unit 145 may output at least one of the user information of the user U and the product information associated with the user information. The reservation notification unit 146 accepts a reservation of the user U for a visit to the real store RS, and notifies the store terminal 200 of the reservation. The purchase acceptance unit 147 accepts purchase of a product desired by the user U online on a website including the product from the store terminal 200.

### <Store Terminal>

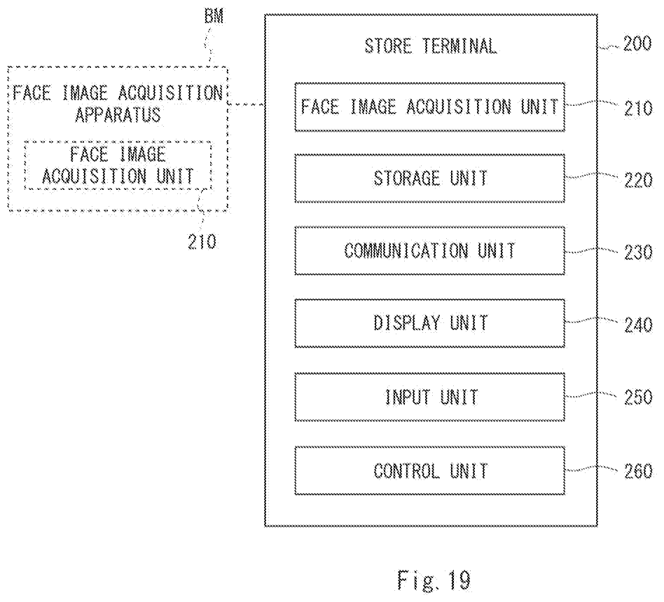

Next, the store terminal 200 will be described. FIG. 19 is a block diagram exemplifying a store terminal 200 according to the fourth example embodiment. As illustrated in FIG. 19, the store terminal 200 includes a face image acquisition unit 210, a storage unit 220, a communication unit 230, a display unit 240, an input unit 250, and a control unit 260. The face image acquisition unit 210, the storage unit 220, the communication unit 230, the display unit 240, the input unit 250, and the control unit 260 have functions as face image acquisition means, storage means, communication means, display means, input means, and control means, respectively.

The face image acquisition unit 210 acquires a face image under the control of the control unit 260. The face image acquisition unit 210 may be disposed in the face image acquisition apparatus BM. The storage unit 220 is a storage apparatus that stores a program for realizing each function of the store terminal 200. The communication unit 230 is a communication interface with the network NW. The display unit 240 is a display apparatus. The display unit 240 may display the behavior history or the like of the user U output from the information processing apparatus 100. The input unit 250 is an input apparatus that receives an input. The display unit 240 and the input unit 250 may be integrally configured like a touch panel. The control unit 260 controls hardware included in the store terminal 200.

### <User Terminal>

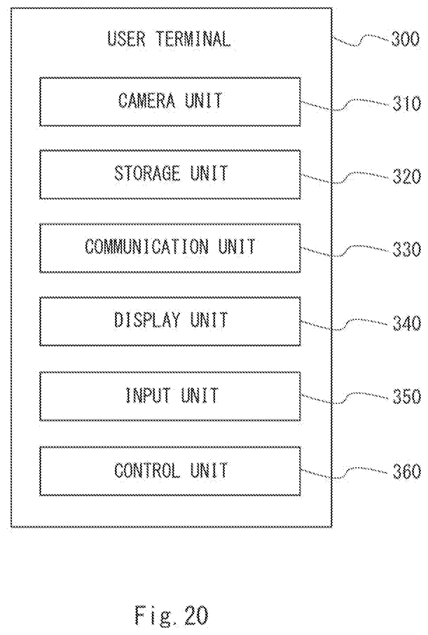

Next, the user terminal 300 will be described. FIG. 20 is a block diagram illustrating a configuration of the user terminal 300 according to the fourth example embodiment. As illustrated in FIG. 20, the user terminal 300 includes a camera unit 310, a storage unit 320, a communication unit 330, a display unit 340, an input unit 350, and a control unit 360. The camera unit 310, the storage unit 320, the communication unit 330, the display unit 340, the input unit 350, and the control unit 360 have functions as camera means, storage means, communication means, display means, input means, and control means, respectively.

The camera unit 310 is an imaging apparatus that performs imaging under the control of the control unit 360. The camera unit 310 may acquire a face image as biometric information. The storage unit 320 is a storage apparatus that stores a program for realizing each function of the user terminal 300. The communication unit 330 is a communication interface with the network NW. The display unit 340 is a display apparatus. The user U displays a website including a product on the display unit 340 to obtain product information. The input unit 350 is an input apparatus that receives an input from the user U. The display unit 340 and the input unit 350 may be integrally configured like a touch panel. The control unit 360 controls hardware included in the user terminal 300.

### <Face Authentication Apparatus>

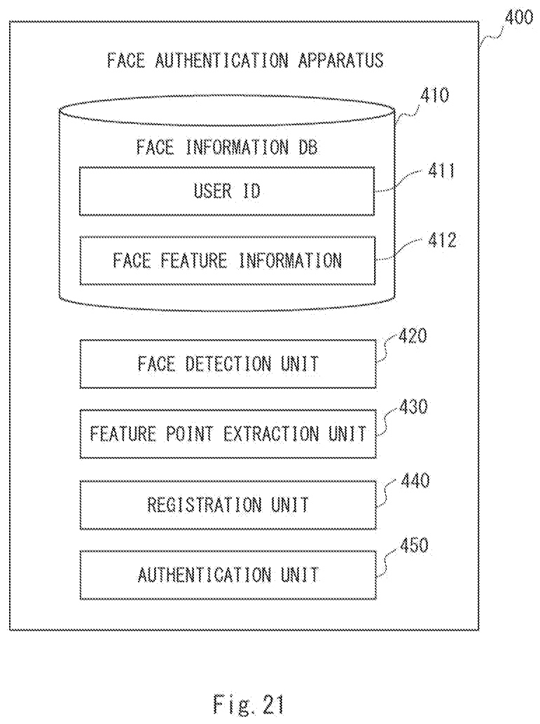

Next, the face authentication apparatus 400 will be described as an example of the biometric authentication apparatus. FIG. 21 is a block diagram illustrating a configuration of the face authentication apparatus 400 according to the fourth example embodiment. The face authentication apparatus 400 includes a face information DB 410, a face detection unit 420, a feature point extraction unit 430, a registration unit 440, and an authentication unit 450. The face information DB 410, the face detection unit 420, the feature point extraction unit 430, the registration unit 440, and the authentication unit 450 have functions as face information DB means, face detection means, feature point extraction means, registration means, and authentication means, respectively.

The face information DB 410 stores a user ID 411 and face feature information 412 of the user ID in association with each other. The user ID 411 is information for identifying a user, and is, for example, an identification number. The face feature information 412 is a set of feature points extracted from the face image, and is an example of face information. Note that the face authentication apparatus 400 may delete the face feature information 412 in the face feature DB 410 in response to a request from a registered user of the face feature information 412. Alternatively, the face authentication apparatus 400 may delete the face feature information 412 after a lapse of a certain period from registration of the face feature information.

The face detection unit 420 detects a face region included in a registration image for registering face information, and supplies the face region to the feature point extraction unit 430. The feature point extraction unit 430 extracts feature points from the face region detected by the face detection unit 420 and supplies face feature information to the registration unit 440. The feature point extraction unit 430 extracts feature points included in a face image received from the information processing apparatus 100, and supplies face feature information to the authentication unit 450.

The registration unit 440 newly issues the user ID 411 when registering the face feature information. The registration unit 440 registers the issued user ID 411 and the face feature information 412 extracted from the registration image in the face information DB 410 in association with each other. The authentication unit 450 performs face authentication using the face feature information 412. Specifically, the authentication unit 450 collates the face feature information extracted from the face image with the face feature information 412 in the face information DB 410. The authentication unit 450 returns whether or not pieces of the face feature information match to the information processing apparatus 100. Whether or not the pieces of face feature information match corresponds to whether authentication has succeeded or failed. A case where the pieces of face feature information match (presence of matching) is a case where the degree of matching is equal to or more than a predetermined value.

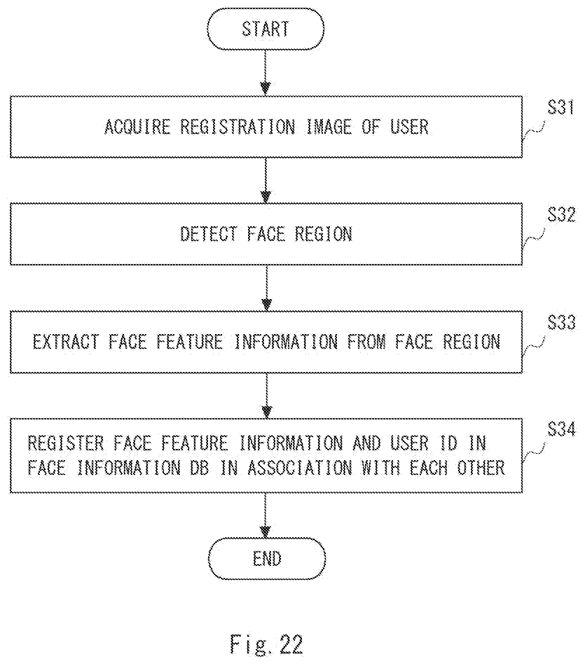

FIG. 22 is a flowchart illustrating a flow of a face information registration process according to the fourth example embodiment. As illustrated in step S31, first, the face authentication apparatus 400 acquires a registration image of the user U included in the face registration request. For example, the face authentication apparatus 400 receives, via the network NW, a face registration request from the information processing apparatus 100 that has received a member registration request from the user terminal 300. The face authentication apparatus 400 is not limited thereto, and may directly receive the face registration request from the user terminal 300.

Next, as illustrated in step S32, the face detection unit 420 detects a face region included in the registration image. Next, as illustrated in step S33, the feature point extraction unit 430 extracts feature points from the face region detected in step S32, and supplies face feature information to the registration unit 440. Finally, as illustrated in step S34, the registration unit 440 issues the user ID 411, and registers the user ID 411 and the face feature information 412 in the face information DB 410 in association with each other. The face authentication apparatus 400 may receive the face feature information 412 from a face registration request source and register the face feature information 412 in the face information DB 410 in association with the user ID 411.

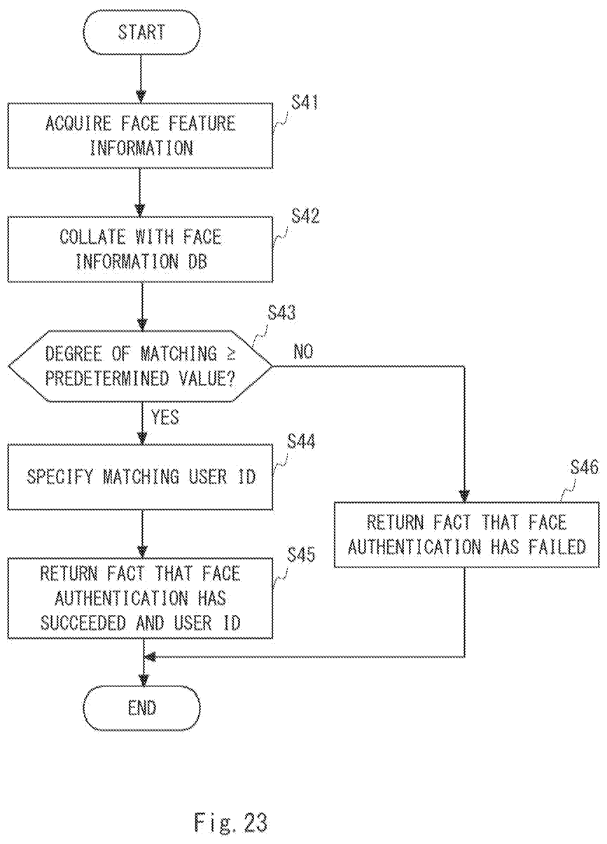

FIG. 23 is a flowchart illustrating a flow of a face authentication process according to the fourth example embodiment. As illustrated in step S41, first, the feature point extraction unit 430 acquires face feature information for authentication. For example, the face authentication apparatus 400 receives the face authentication request from the information processing apparatus 100 via the network N, and extracts the face feature information from the face image included in the face authentication request as in steps S31 to S33. Alternatively, the face authentication apparatus 400 may receive the face feature information from the information processing apparatus 100.

Next, as illustrated in step S42, the authentication unit 450 collates the acquired face feature information with the face feature information 412 in the face information DB 410. Next, as illustrated in step S43, it is determined whether the face features match. Specifically, in a case where the pieces of face feature information match in step S43, that is, in a case of YES in which the matching degree of the face feature information is equal to or more than a predetermined value, as illustrated in step S44, the authentication unit 450 specifies the user ID 411 of the user whose face feature information matches. As illustrated in step S45, the authentication unit 450 returns the fact that the face authentication has succeeded and the specified user ID 411 to the information processing apparatus 100 as face authentication results.

On the other hand, in a case of NO in step S43 in which there is no matching face feature information, as illustrated in step S46, the authentication unit 450 returns the fact that the face authentication has failed to the information processing apparatus 100 as a face authentication result.

According to the present example embodiment, the information processing system 4 can cause the configurations of the store terminal 200, the user terminal 300, and the face authentication apparatus 400 connected to the information processing apparatus 100 to cooperate with each other. Therefore, the convenience for the user U and the salesperson P can be improved, and the sales of the real store RS can be improved.

Note that the present disclosure is not limited to the above example embodiments, and can be appropriately changed without departing from the concept. For example, it is also possible to combine each configuration of the first to fourth example embodiments.

In the above example embodiments, the biometric authentication apparatus has the biometric authentication function. However, the information processing apparatus may have the biometric authentication function instead of or in addition to the biometric authentication apparatus.

An information processing program that causes a computer to read and execute the above-described information processing method is also within the scope of the technical idea of the example embodiments. The information processing program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage apparatus. The information processing program may be transmitted on a transitory computer-readable medium or a communication medium. As an example and not by way of limitation, the transitory computer-readable medium or the communication medium includes propagated signals in electrical, optical, acoustic, or any other form.

Some or all of the above-described example embodiments can be described as in the following Supplementary Notes, but are not limited to the following Supplementary Notes.

### (Supplementary Note 1)

An information processing apparatus including:
collecting means for collecting a user's online behavior history on a website including a product;
registration means for registering the behavior history in association with a user ID of the user;
acquisition means for acquiring biometric information of the user acquired in a real store that the user has visited from a store terminal provided in the real store;
specifying means for specifying the user ID of the user by controlling biometric authentication on the basis of the biometric information; and
output means for outputting the behavior history associated with the user ID to the store terminal in a case where the biometric authentication is successful.

### (Supplementary Note 2)

The information processing apparatus according to Supplementary Note 1, in which the output means outputs at least one of user information of the user and product information associated with the user information in addition to the behavior history.

### (Supplementary Note 3)

The information processing apparatus according to Supplementary Note 2, in which
the product includes a cosmetic product,
the user information includes at least one of attribute information of the user and information indicating preference of the user, and
the product information associated with the user information includes the cosmetic product that is in fashion for at least one of the same generation, the same occupation, the same educational background, and the same hometown as the user.

### (Supplementary Note 4)

The information processing apparatus according to any one of Supplementary Notes 1 to 3, further including reservation notification means for accepting a reservation of the user for a visit to the real store and notifying the store terminal of the reservation.

### (Supplementary Note 5)

The information processing apparatus according to Supplementary Note 4, in which the behavior history includes the reservation for the visit to the real store and information regarding the product associated with the visit.

### (Supplementary Note 6)

The information processing apparatus according to any one of Supplementary Notes 1 to 5, further including purchase acceptance means for accepting, from the store terminal, purchase of the product desired by the user online on the website including the product.

### (Supplementary Note 7)

An information processing system including:
a store terminal provided in a real store; and
an information processing apparatus connected to the store terminal via a wireless or wired communication line, in which
the information processing apparatus includes
collecting means for collecting a user's online behavior history on a website including a product,
registration means for registering the behavior history in association with a user ID of the user,
acquisition means for acquiring biometric information of the user acquired in a real store that the user has visited from a store terminal,
specifying means for specifying the user ID of the user by controlling biometric authentication on the basis of the biometric information, and
output means for outputting the behavior history associated with the user ID to the store terminal in a case where the biometric authentication is successful.

### (Supplementary Note 8)

The information processing system according to Supplementary Note 7, further including a biometric authentication apparatus, connected to the information processing apparatus via the wireless or wired communication line, configured to acquire biometric information of the user acquired in the real store and to execute biometric authentication using the biometric information.

### (Supplementary Note 9)

The information processing system according to Supplementary Note 7 or 8, further including a user terminal, connected to the information processing apparatus via the wireless or wired communication line, via which the user acquires information regarding the product online on the website including the product.

### (Supplementary Note 10)

The information processing system according to any one of Supplementary Notes 7 to 9, in which
the information processing apparatus further includes reservation notification means for accepting a reservation of the user for a visit to the real store and notifying the store terminal of the reservation, and
in a case where the reservation has been accepted from the user, the store terminal notifies the reservation notification means of completion of the reservation.

### (Supplementary Note 11)

The information processing system according to any one of Supplementary Notes 7 to 10, further including: purchase acceptance means for accepting, from the store terminal, purchase of the product desired by the user online on the website including the product,
in which the store terminal outputs the product to be purchased and user information to the information processing apparatus.

### (Supplementary Note 12)

An information processing method including:
collecting a user's online behavior history on a website including a product;
registering the behavior history in association with a user ID of the user;
acquiring biometric information of the user acquired in a real store that the user has visited from a store terminal provided in the real store;
specifying the user ID of the user by controlling biometric authentication on the basis of the biometric information; and
outputting the behavior history associated with the user ID to the store terminal in a case where the biometric authentication is successful.

### (Supplementary Note 13)

A non-transitory computer-readable medium storing an information processing program for causing a computer to execute:
a step of collecting a user's online behavior history on a website including a product;
a step of registering the behavior history in association with a user ID of the user;
a step of acquiring biometric information of the user acquired in a real store that the user has visited from a store terminal provided in the real store;
a step of specifying the user ID of the user by controlling biometric authentication on the basis of the biometric information; and
a step of outputting the behavior history associated with the user ID to the store terminal in a case where the biometric authentication is successful.

### REFERENCE SIGNS LIST

1, 4 INFORMATION PROCESSING SYSTEM
10, 10a, 10b INFORMATION PROCESSING APPARATUS
11 COLLECTING UNIT
12 REGISTRATION UNIT
13 ACQUISITION UNIT
14 SPECIFYING UNIT
15 OUTPUT UNIT
16 RESERVATION NOTIFICATION UNIT
17 PURCHASE ACCEPTANCE UNIT
20 STORE TERMINAL
21 IMAGE ACQUISITION APPARATUS
30 USER TERMINAL
40 BIOMETRIC AUTHENTICATION APPARATUS
41 FACE AUTHENTICATION APPARATUS
100 INFORMATION PROCESSING APPARATUS
110 STORAGE UNIT
111 PROGRAM
112 USER DB
113 STORE INFORMATION DB
114 PRODUCT INFORMATION DB
115 BEHAVIOR HISTORY DB
120 MEMORY
130 COMMUNICATION UNIT
140 CONTROL UNIT
141 COLLECTING UNIT
142 REGISTRATION UNIT
143 ACQUISITION UNIT
144 SPECIFYING UNIT
145 OUTPUT UNIT
146 RESERVATION NOTIFICATION UNIT
147 PURCHASE ACCEPTANCE UNIT
200 STORE TERMINAL
210 FACE IMAGE ACQUISITION UNIT
220 STORAGE UNIT
230 COMMUNICATION UNIT
240 DISPLAY UNIT
250 INPUT UNIT
260 CONTROL UNIT
300 USER TERMINAL
310 CAMERA UNIT
320 STORAGE UNIT
330 COMMUNICATION UNIT
340 DISPLAY UNIT
350 INPUT UNIT
360 CONTROL UNIT
400 FACE AUTHENTICATION APPARATUS
410 FACE INFORMATION DB
411 USER ID
412 FACE FEATURE INFORMATION
420 FACE DETECTION UNIT
430 FEATURE POINT EXTRACTION UNIT
440 REGISTRATION UNIT
450 AUTHENTICATION UNIT
1121 USER ID
1122 USER INFORMATION
1131 STORE ID
1132 STORE INFORMATION
1141 PRODUCT INFORMATION
1151 USER ID
1152 BEHAVIOR HISTORY
BM BIOMETRIC INFORMATION ACQUISITION APPARATUS
NW NETWORK
P SALESPERSON
RS REAL STORE
U USER

What is claimed is:

1. An information processing apparatus comprising:
at least one memory storing instructions, and
at least one processor configured to execute the instructions to:
collect a user's online behavior history on a website including a product;
register the behavior history in association with a user ID of the user;
acquire biometric information of the user acquired in a real store that the user has visited from a store terminal provided in the real store;
specify the user ID of the user by controlling biometric authentication on the basis of the biometric information; and
output the behavior history associated with the user ID to the store terminal in a case where the biometric authentication is successful.

2. The information processing apparatus according to claim 1, wherein the processor executes the instruction to output at least one of user information of the user and product information associated with the user information in addition to the behavior history.

3. The information processing apparatus according to claim 2, wherein
the product includes a cosmetic product,
the user information includes at least one of attribute information of the user and information indicating preference of the user, and
the product information associated with the user information includes the cosmetic product that is in fashion for at least one of the same generation, the same occupation, the same educational background, and the same hometown as the user.

4. The information processing apparatus according to claim 1, further comprising the processor executes the instruction to accept a reservation of the user for a visit to the real store and notifying the store terminal of the reservation.

5. The information processing apparatus according to claim 4, wherein the behavior history includes the reservation for the visit to the real store and information regarding the product associated with the visit.

6. The information processing apparatus according to claim 1, further comprising the processor executes the instruction to accept, from the store terminal, purchase of the product desired by the user online on the website including the product.

7. An information processing system comprising:
a store terminal provided in a real store; and
an information processing apparatus connected to the store terminal via a wireless or wired communication line, wherein
the information processing apparatus includes
at least one memory storing instructions, and
at least one processor configured to execute the instructions to:
collect a user's online behavior history on a website including a product,
register the behavior history in association with a user ID of the user,
acquire biometric information of the user acquired in a real store that the user has visited from a store terminal
specify the user ID of the user by controlling biometric authentication on the basis of the biometric information, and
output the behavior history associated with the user ID to the store terminal in a case where the biometric authentication is successful.

8. The information processing system according to claim 7, further comprising a biometric authentication apparatus, connected to the information processing apparatus via the wireless or wired communication line, configured to acquire biometric information of the user acquired in the real store and to execute biometric authentication using the biometric information.

9. The information processing system according to claim 7, further comprising a user terminal, connected to the information processing apparatus via the wireless or wired communication line, via which the user acquires information regarding the product online on the website including the product.

10. The information processing system according to claim 7, wherein
the information processing apparatus further includes the processor executes the instruction to accept a reservation of the user for a visit to the real store and notifying the store terminal of the reservation, and
in a case where the reservation has been accepted from the user, the store terminal notifies the reservation notification means of completion of the reservation.

11. The information processing system according to claim 7, further comprising: the processor executes the instruction to accept, from the store terminal, purchase of the product desired by the user online on the website including the product,
wherein the store terminal outputs the product to be purchased and user information to the information processing apparatus.

12. (canceled)

13. A non-transitory computer-readable medium storing an information processing program for causing a computer to execute:
a step of collecting a user's online behavior history on a website including a product;
a step of registering the behavior history in association with a user ID of the user;
a step of acquiring biometric information of the user acquired in a real store that the user has visited from a store terminal provided in the real store;
a step of specifying the user ID of the user by controlling biometric authentication on the basis of the biometric information; and
a step of outputting the behavior history associated with the user ID to the store terminal in a case where the biometric authentication is successful.
